(19) United States
(12) Patent Application Publication
(10) Pub. No.: US 2011/0202570 A1
(43) Pub. Date: Aug. 18, 2011

(54) Method for structuring hierarchical data in relational databases

(75) Inventor: Souheil ZINA, Guyancourt (FR)

(73) Assignee: LASCOM, Bievres (FR)

(21) Appl. No.: 13/028,001

(22) Filed: Feb. 15, 2011

(30) Foreign Application Priority Data
Feb. 16, 2010 (FR) 10 00649

(51) Int. Cl. G06F 17/30

(52) U.S. Cl. 707/797; 707/E17.005; 707/E17.045

(57) ABSTRACT

In a method for structuring, in an ordered tree of predetermined depth P′, of data complying with predetermined criteria Fs and organized in a directed acyclic graph of depth P which comprises nodes and links between the nodes, the nodes and links stored by type in tables of a relational database which is queried by a query language from an application server connected to a user interface, the criteria Fs being determined on the nodes and/or the links, the method includes: creation of a “CACHE” table in the database; determination by the database of a set E; running of an iteration having an identifier id and/or properties; and transmission by the database to the application server of an end-of-process item of information with the number of nodes loaded into the “CACHE” table and of an identifier for access to the “CACHE” table. The iteration includes: determination by the database of the set S of children of the nodes of E complying with the criteria Fs; insertion by the database of the nodes of the set S and of their respective indices in the “CACHE” table; determination by the application server of criteria Fe as a function of the depth P′, of the identifier id and/or of properties of the iteration; determination by the database of the set E by applying the criteria Fe to all of the nodes in the “CACHE” table; and P′=P′−1. The iteration steps are repeated while P′>0 and S≠Ø.

The field of the invention is that of structuring, searching and navigation in hierarchical data sets stored in relational databases.

The concept of hierarchy is omnipresent in systems for managing technical data, for managing configurations and more generally for managing the lifecycle of products (PLM or Product Lifecycle Management). The main feature of these applications lies in their ability to structure and manage the change in the various data, while maintaining the cohesion and integrity of the information.

The data are represented in the form of information with multiple levels of detail. These data are organized with the aid of directed acyclic graph structures (or DAG). The depth P is representative of these levels of detail.

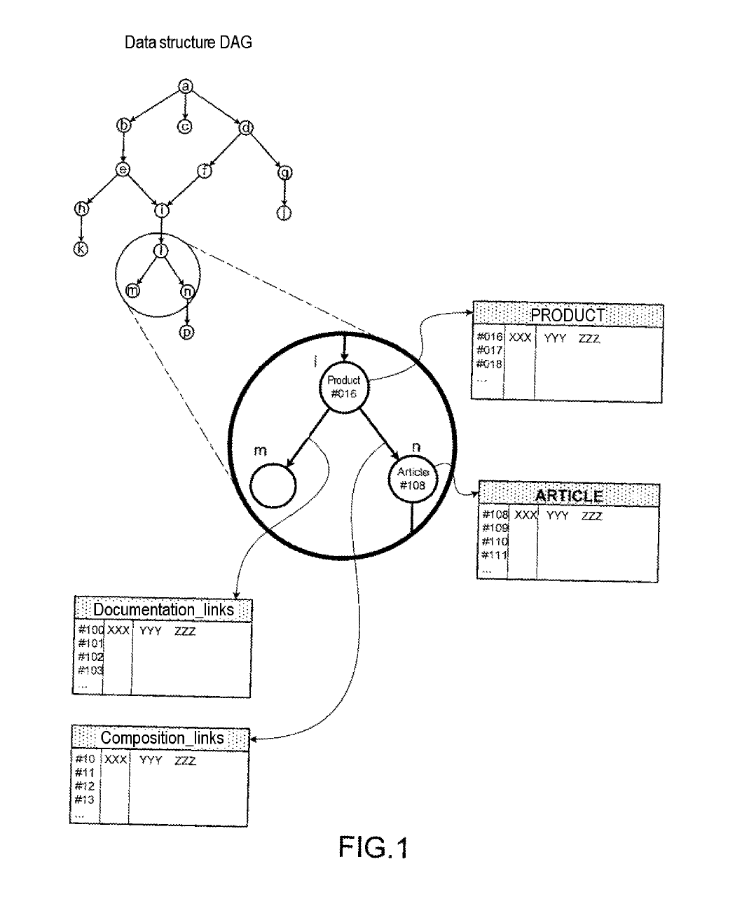

A graph consists of a set of nodes, the nodes being connected together by directed links. A path is a sequence of consecutive links all traveled in the same direction: each link of the sequence has one end in common with the previous link. A cycle is a path in which a node appears at least twice. A DAG of which an example is given in FIG. 1 is a graph in which all the links are directed and which has no cycle. In this example, the depth P equals 6, the root not being counted.

This hierarchical organization in a DAG makes it possible to provide links for navigating from one node to another irrespective of their relative position in the hierarchy. There may be several possible paths between two nodes of the graph such as for example between the nodes “a” and “i” of FIG. 1, which corresponds to different contexts of use.

The links are typed; each type of link is identified by its own set of properties (dates for the start and end of validity, quantities, etc.) making it possible to describe more precisely the relationships between the nodes and thus allowing the traceability of the changes of these graphs. Two types of links are shown in the example of FIG. 1: the “documentation” type and the “composition” type.

Each node of the graph is associated with a technical object. “Technical object” means an item of information used as a basis for a reasoning on which the processes are carried out. The technical objects are typed; each type of object is identified by its own set of properties. Two types of technical objects are shown in the example of FIG. 1: the “Product” type and the “Article” type.

The data are managed by a relational database management system (RDBMS). These data are saved in tables with two dimensions (rows and columns). One table is associated with each type of technical object (respectively type of link). In the example, there are four tables: “Documentation”, “Composition”, “Product” and “Article”. These data are handled according to the relational algebra theory. RDBMSs are widely used in industry for reasons of maturity, performance and simplicity.

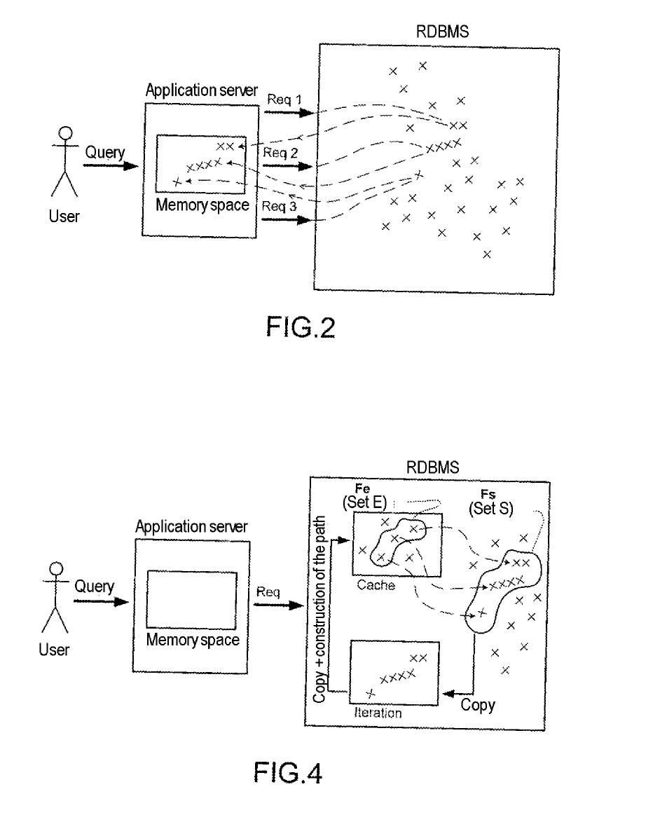

These data are handled by the application server, depending on the specialism specifics of the applications (the term is specialism logic or application logic). The application server provides the interface between the user and the data stored and managed by the RDBMS as shown in FIG. 2. This figure shows how a query “query” is broken down into three queries “req1, req2, req3” by the application server in order to obtain all of the expected nodes.

The organization of HTML documents on the Web can also be modelled with a graph structure. However, these graphs are not DAGs because there may be cycles. Moreover, the links between the nodes of the graph of an HTML document are not typed and bear no properties. It is clear to those skilled in the art that our problem differs from the organization of HTML documents on the Web.

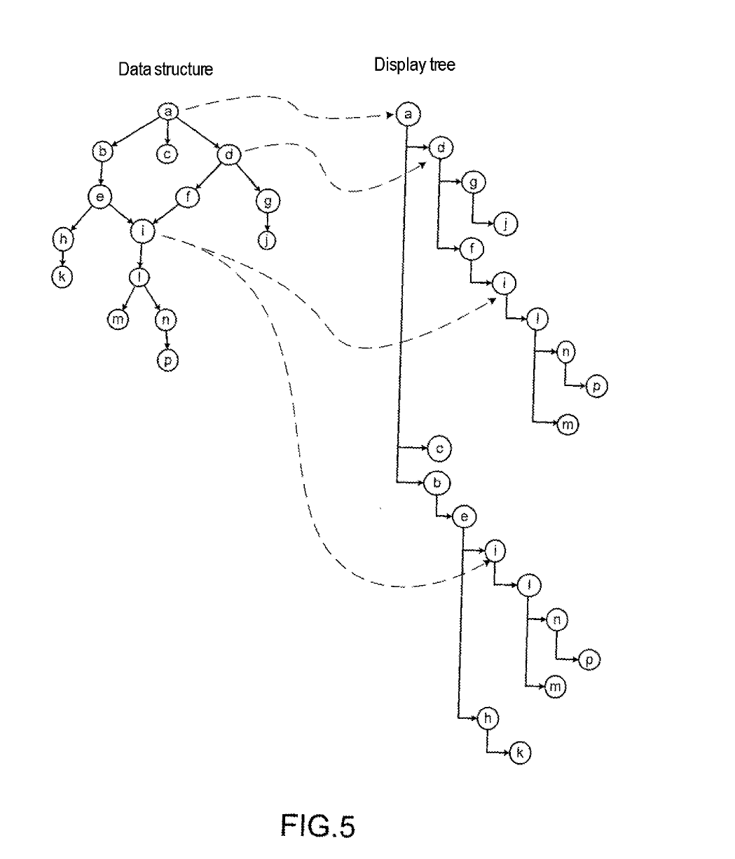

The handling of these hierarchical data by the user is based on arborescent display structures. A display tree provides the user with a medium for paging and more generally for navigating in these graphs. An example of a display tree associated with the DAG of FIG. 1 is shown in FIG. 5. The display tree of a DAG has the same depth P as the said DAG. Note that paging consists in displaying a portion of a tree. This display tree is obtained by the application of filters on these hierarchical data organized in a DAG. Each node of the DAG is shown in the display tree n times; n being the number of links that point (incoming links) to this node in the DAG. In the example of FIG. 5, the node “i” is represented twice in the display tree.

A filter consists of a set of search criteria. The searches in these graph structures are very frequently made with criteria that relate both to the properties of the technical objects and to the properties of the links. For certain types of searches, the criteria on the properties of the links must be verified over the whole path between the start node and the finish node.

Database queries are therefore not easy because the relationship between the node of the graph and the instance of the technical object takes the form of a reference to different tables depending on the type of instances. An “instance of a type of object” (respectively type of link) is an occurrence or a record in the table associated with this type of object (respectively type of link). FIG. 1 illustrates the storage of data in the form of a directed acyclic graph and the tables of the associated RDBMS. For the “Product” table, 3 instances are indicated (#016, #017, #018), 4 are indicated for the “Article” table (#108, #109, #110, #111), “Documentation” table (#100, #101, #102, #103), and “Composition” table (#10, #11, #12, #13). The node “I” references an instance (#016) in the “Product” table. The node “n” references an instance (#108) in the “Article” table.

It is known practice to carry out searches in a database in a recursive manner. For a given node of the graph, all the child nodes are searched for that satisfy the search criteria expressed by the user and then the process recommences for each of the nodes obtained up to the level of detail requested by the user. It is possible to cite as a search example that which consists in loading the mechanical elements of a vehicle engine up to the level of the elementary components (piston, connecting rod, etc.). Accordingly, for each query, all of the data that form the graph are loaded onto the application server and processed in memory as illustrated in FIG. 2.

Although this recursive approach makes it possible to process small graphs, it is inappropriate for voluminous hierarchical structures with several levels of nesting. Specifically, the number of queries processed by the database server and the size of the memory space used by the application server are proportional to the number of nodes loaded. For a graph comprising for example 3000 nodes distributed over 3 levels, it is therefore necessary to execute 3000 queries in order to load these 3000 nodes into the memory space. The processing time for the search then increases in the same proportions until it causes a considerable annoyance for the user. The performance of this search is greatly linked to the performance of the application server and of its connection with the database server. One solution consists in using a more powerful server while increasing the bit rate between the server and the RDBMS. This solution could be extremely costly and has limits in terms of scalability.

Consequently, to this day there is still a need for a system simultaneously satisfying all of the aforementioned requirements, in terms of processing time, of volume of processed data, of cost of the system and of ease of use.

The constraints that it is sought to improve are mainly the processing time and the volume of data managed by the RDBMS. It is also sought to improve the scalability of the application server and of the RDBMS. Scalability takes account of the number of users connected simultaneously to the system.

This optimization of the processing time consists in reducing the number of queries sent to the RDBMS by the application server and the volume of data processed by the application server because the applicant has noted that very frequently the application server is the bottleneck. This also makes it possible to retrieve in a very short time all of the objects and their properties contained in any segment (also called a page) of the display tree.

The invention is based on preparing the data of the graph directly in the RDBMS so that they are easily exploitable by the application server.

The principle of the invention is based on an iterative approach which uses two RDBMS tables:

a “CACHE” table for storing all of the nodes and links that form the display tree,

an “ITERATION” table for storing the intermediate results obtained by the various iterations.

This involves structuring the data in the form of an ordered tree which satisfies the search criteria expressed by the user. These search criteria relate both to the properties of the technical objects and/or the properties of the links.

More precisely, the subject of the invention is a method for structuring, in an ordered tree of predetermined depth P′, data complying with predetermined criteria Fs and organized in the form of a directed acyclic graph of depth P which comprises nodes and links between these nodes, these nodes and links being stored by type in tables of a relational DBMS capable of being queried by a query language from an application server connected to a user interface, the criteria Fs being determined on the nodes and/or the links. It is mainly characterized in that it comprises the following steps:
a) creation of a “CACHE” table in the RDBMS,
b) determination by the RDBMS of a set E,
c) running of an iteration having an identifier id and/or properties, which comprises the following sub-steps:
   i) determination by the RDBMS of the set S of children of the nodes of E complying with the criteria Fs,
   ii) insertion by the RDBMS of the nodes of the set S and of their respective indices in the “CACHE” table,
   iii) determination by the application server of criteria Fe as a function of the depth P′, of the identifier id and/or of properties of the iteration,
   iv) determination by the RDBMS of the set E by applying the criteria Fe to all of the nodes in the “CACHE” table,
   v) P′=P′−1, repeat steps i, ii, iii, iv and v of the iteration while P′>0 and S≠Ø,
d) transmission by the RDBMS to the application server of an end-of-process item of information with the number of nodes loaded into the “CACHE” table and of an identifier for access to the “CACHE” table.

According to one feature of the invention, each child node is associated with an index which makes it possible to locate the node uniquely in the tree.

Step ii) typically comprises the following sub-steps:
copying the set S into an “ITERATION” table,
computing the index for each node of S and
adding nodes of S to the “CACHE” table, the latter nodes being respectively associated with their index.

A further subject of the invention is a relational database management system which comprises means for applying the method for structuring data in an ordered tree as described.

Other features and advantages of the invention will appear on reading the following detailed description made as a non-limiting example and with reference to the appended drawings in which:

FIG. 1 illustrates the storage of data in the form of a directed acyclic graph and the tables of the associated RDBMS,

FIG. 2 represents schematically certain steps of a data-structuring method according to the prior art,

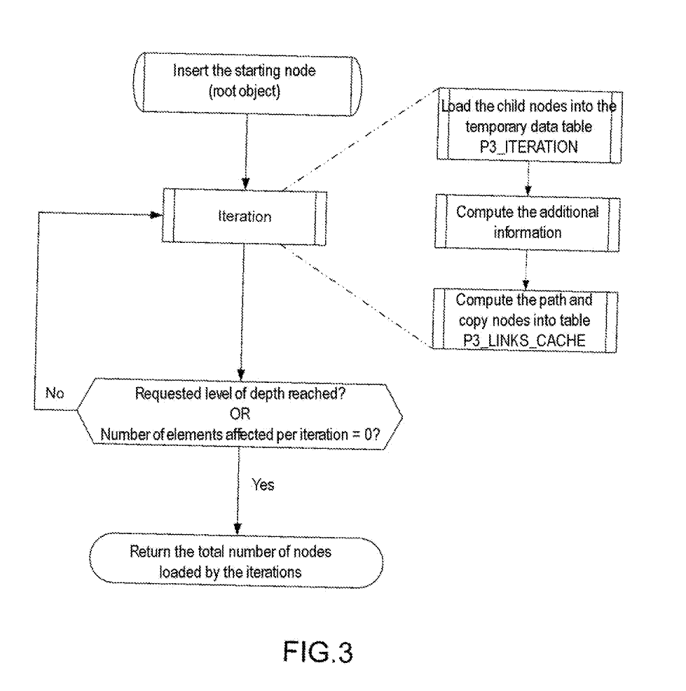

FIG. 3 represents a flow chart of the general course of the data-structuring method according to the invention,

FIG. 4 represents schematically certain steps of a data-structuring method according to the invention,

FIG. 5 represents schematically an example of a display tree originating from the directed acyclic graph of FIG. 1.

From one figure to the next, the same elements are indicated by the same references.

The general course of the data-structuring method according to the invention is illustrated by FIG. 3. It is executed by the RDBMS.

A first step consists in inserting into the “CACHE” table a starting assembly. A starting assembly usually comprises the starting object that is called the “root object”, but it may comprise several root objects.

Then begins a cycle of iterations that will make it possible to index in the form of an ordered list all of the data necessary to construct the display tree. Note that indexing makes it possible to know whether a node is descending from another node, by simple comparison of the indices of these nodes, that is to say by comparison of these ordered lists.

The number of iterations is equal to the level of depth P′ (or level of breakdown) requested by the user. The level P′ is an integer value expressed by the user which represents the level of detail that he wishes to achieve; this gives P′ P.

Each iteration has properties which make it possible to identify it and uses two criteria filters: an input filter Fe and an output filter Fs illustrated in FIG. 4.

The result of an iteration is a set S of nodes considered to be children of the nodes used as input and which have satisfied the criteria of the output filter Fs; the criteria of the output filter are the search criteria expressed by the query “req” of the user. These child nodes are copied into the “ITERATION” table and then, as will be seen below, to the “CACHE” table. For the first iteration, the set of nodes used as input is the starting set.

The set E of the nodes used as input of the next iteration, also called the new set E, is obtained by applying a filter Fe to the result of the previous iteration, that is to say to the set S: this new set E is therefore the set S or a subset of S. The criteria of the input filter Fe are constructed automatically by the application server. According to one particular embodiment of the invention, these criteria are based on the depth P′ and on the number of iterations i carried out (level of breakdown). According to another embodiment of the invention, the criteria of the filter Fe are based on the properties of identifications of the iterations.

These filters will be illustrated by an example based on the DAG of FIG. 1. The criterion of Fs consists for example in choosing all the children of the nodes of the starting set E.

For the 1^{st} iteration (id=1), E=“a”, the root node “a” is inserted into the “CACHE” table. By applying Fs to E, which has 3 children, we obtain S=“b, c, d”. The set S is inserted into the “CACHE” table. This table therefore contains the nodes “a, b, c, d”. The identifier “id” is associated with each node loaded into the “CACHE” table which comprises for example a new “id” column.

For the 2^{nd} iteration (id=2), first of all Fe is applied to all of the nodes present in the “CACHE” table, in order to obtain E. The criteria of Fe consist for example in taking as set E, the output set S of the previous iteration; this therefore gives E=“b, c, d”. By applying Fs to E, we obtain S=“e, f, g”. The set S is inserted into the “CACHE” table. This table therefore contains the nodes “a, b, c, d, e, f, g”.

For the 3^{rd} iteration (id=3), first of all Fe is applied to all of the nodes present in the “CACHE” table, in order to obtain E. The criteria of Fe consist in taking as set E, the output set S of the previous iteration; this therefore gives E=“e, f, g”. By applying Fs to E, we obtain S=“h, i, i, j”. It will be noted that the node “i” is present twice in the output set S, because in the example of FIG. 1, “i” is a child of the nodes “e” and “f”. The set S is inserted into the “CACHE” table. This table therefore contains the nodes “a, b, c, d, e, f, g, h, i, i, j”.

For the 4^{th} iteration (id=4), first of all Fe is applied to all of the nodes present in the “CACHE” table in order to obtain E. The criteria of Fe consist in taking as set E the output set S of the previous iteration; this therefore gives E=“h, i, i, j”. By applying Fs to E, this gives S=“k, I, I”. It will be noted that the node “I” is present twice in the output set S because its parent node “i” is present twice in the input set E. The set S is inserted into the “CACHE” table. This table therefore contains the nodes “a, b, c, d, e, f, g, h, i, i, j, k, I, I”.

For the 5^{th} iteration (id=5), first of all Fe is applied to all of the nodes present in the “CACHE” table in order to obtain E. The criteria of Fe consist in taking as set E, the output set S of the previous iteration; this therefore gives E=“k, I, I”. By applying Fs to E, this gives S=“m, n, m, n”. It will be noted that the nodes “m, n” are present twice in the output set S because their parent node “I” is present twice in the input set E. The set S is inserted into the “CACHE” table. This table therefore contains the nodes “a, b, c, d, e, f, g, h, i, i, j, k, I, I, m, n, m, n”.

For the 6^{th} iteration (id=6), first of all Fe is applied to all of the nodes present in the “CACHE” table in order to obtain E. The criteria of Fe consist in taking as set E, the output set S of the previous iteration; this therefore gives E=“m, n, m, n”. By applying Fs to E, this gives S=“p, p”. It will be noted that the node “p” is present twice in the output set S, because its parent node “n” is present twice in the input set E. The set S is inserted into the “CACHE” table. This table therefore contains the nodes “a, b, c, d, e, f, g, h, i, i, j, k, I, I, m, n, m, n, p, p”.

It will be noted that id designated as the identifier of the iteration varies from 1 to P; generally this identifier id varies from 1 to I where I P notably when the starting set is not the root node. It would be possible for example to take as the starting set E=“h, i, j”.

In the previous example, the identifier is the iteration No.; in another example, the identifier id could be a random code.

It will be noted that, at the end of the cycle of iterations, the “CACHE” table contains all of the nodes that form the display tree shown in FIG. 5.

More precisely, each iteration comprises the following sub-steps:
Loading of the child nodes:
   The filter Fe is determined by the application server depending on the depth P′, on the identifier and if necessary on other properties of the iteration.
   The input nodes are obtained by applying the filter Fe to the nodes stored in the “CACHE” table. This set of input nodes is designated E; in FIG. 4, E comprises 3 input nodes obtained by applying Fe to the 6 nodes of the “CACHE” table. This step determines the types of technical objects involved in the search criteria defined by the user.
   For each type of technical object obtained by the previous step, the application of the filter Fs, that is to say the application of the search criteria defined by the user, makes it possible to load all the nodes considered to be children of the set E of the input nodes. S designates this set of child nodes; in FIG. 4, S comprises 7 child nodes, 2 children originating from a first input node, 4 originating from a second input node and one originating from the third input node. This step causes the intervention of the relationships (also designated joints) between different tables of the RDBMS; the result, that is to say the set S, is copied into the “ITERATION” table. The number of queries in the RDBMS corresponds to the number of types of technical objects concerned.
Loading of additional information: this optional step makes it possible to compute the information linked to the loaded nodes and optionally useful for constructing the display tree or for continuing the cycle of iterations. For example, computing for a node the number of its descendants or loading its status.
Computation of the path (or more generally indexation): the result of the previous two steps is a set S of nodes considered to be children of the input set E, with which optionally additional information is associated.
This step makes it possible to copy this result S into the “CACHE” table by associating, for each node, the path (or more generally the index) that makes it possible to locate uniquely each node in the tree structure; this path is unique since it involves a tree. The sorting order defined by the user is taken into account in the computation of this path. This result S is inserted after the result of the previous iteration; as the iterations progress, the “CACHE” table is enhanced. There are several modes for computing the path. One example of a computing mode is to convert the rank of each node into hexadecimal and then to concatenate it with the path of its parent node. Another example is to use a binary path.

To summarize, each iteration is based on the set E of input nodes stored in the “CACHE” table, the set S of output nodes being copied into this same “CACHE” table. Therefore, the result of an iteration corresponds to the set of input nodes of the next iteration.

The final result obtained in the “CACHE” table corresponds to the structure of the display tree that has satisfied the search criteria and the sorting order expressed by the user.

The cycle of iterations stops if the level of depth P′ is reached or if the result S of an iteration is empty (all of the input nodes have no child).

The paging of the display tree is based on segments obtained by adding criteria to the paths of the nodes indexed in the “CACHE” table. For example, in order to search for the descendants of any node “n” of the display tree stored in the “CACHE” table, it is sufficient to search for all the nodes of which the path begins with the path of the node “n”.

At the end of the process, the RDBMS sends to the application server an end-of-process item of information with the number of nodes loaded into the “CACHE” table and an identifier for access to this table.

1. A method for structuring, in an ordered tree of predetermined depth P′, data complying with predetermined criteria Fs and organized in the form of a directed acyclic graph of depth P which comprises nodes and links between the nodes, the nodes of different types and the links of different types being stored in tables of a relational database management system, with one table per type of node or of link, this relational database management system configured to be queried by a query language from an application server connected to a user interface, the criteria Fs being determined on one or more of the nodes and the links, said method comprising:
creation of a “CACHE” table in the relational database management system;
determination by the relational database management system of a starting set E comprising one or more predetermined root nodes of the directed acyclic graph;
running of an iteration having an identifier “id” initially equal to 1, or properties, said running of the iteration comprising:
determination by the relational database management system of the set S of children of the nodes of E complying with the criteria Fs;
insertion by the relational database management system of the nodes of the set S and of their respective indices in the “CACHE” table;
determination by the relational database management system of a new set E by applying to all of the nodes of the “CACHE” table criteria Fe for selecting the set or a subset of the nodes of S, determined as a function of the depth P′, of the identifier “id” or of properties of the iteration;
P′=P′−1, id=id+1; and
repeating the determination of the set S, the insertion of the nodes, and the determination of the new set E of the iteration while P′>0 and S≠Ø; and
transmission by the RDBMS relational database management system to the application server of an end-of-process item of information with the number of nodes loaded into the “CACHE” table and of an identifier for access to the “CACHE” table.

2. The method for structuring data in an ordered tree according to claim 1, wherein each child node is associated with an index to locate the node uniquely in the tree.

3. The method for structuring data in an ordered tree according to claim 2, wherein the step of insertion by the relational database management system of the nodes of the set S and of their respective indices in the “CACHE” table comprises:
copying the set S into an “ITERATION” table;
computing the index for each node of S; and
adding nodes of S to the “CACHE” table, the latter nodes being respectively associated with their index.

4. A relational database management system comprising means for applying the method for structuring data in an ordered tree according to claim 1.

5. A relational database management system comprising means for applying the method for structuring data in an ordered tree according to claim 2.

6. A relational database management system comprising means for applying the method for structuring data in an ordered tree according to claim 3.

7. A relational database management system comprising means for applying the method for structuring data in an ordered tree according to claim 4.
